(19) United States
(12) Patent Application Publication
(10) Pub. No.: US 2013/0031309 A1
(43) Pub. Date: Jan. 31, 2013

(54) SEGMENTED CACHE MEMORY

(71) Applicant: Commissariat a l'Energie Atomique et aux Energie, Paris (FR)

(72) Inventors: Vincent DAVID, Marcoussis (FR); Renaud SIRDEY, Cernay La Ville (FR)

(73) Assignee: Commissariat a l'Energie Atomique et aux Energies Alternatives, Paris (FR)

(21) Appl. No.: 13/645,907

(22) Filed: Oct. 5, 2012

Related U.S. Application Data
(63) Continuation of application No. PCT/IB2011/051361, filed on Mar. 30, 2011.

(30) Foreign Application Priority Data
Apr. 9, 2010 (FR) 10 01494

(51) Int. Cl. G06F 12/08

(52) U.S. Cl. 711/127; 711/E12.042

(57) ABSTRACT

A cache memory associated with a main memory and a processor capable of executing a dataflow processing task, includes a plurality of disjoint storage segments, each associated with a distinct data category. A first segment is dedicated to input data originating from a dataflow consumed by the processing task. A second segment is dedicated to output data originating from a dataflow produced by the processing task. A third segment is dedicated to global constants, corresponding to data available in a single memory location to multiple instances of the processing task.

### CROSS-REFERENCE TO RELATED APPLICATIONS

This application is a Continuation of International Application No. PCT/IB2011/051361, filed Mar. 30, 2011, which was published in the French language on Oct. 13, 2011, under International Publication No. WO 2011/125001 A1 and the disclosure of which is incorporated herein by reference.

### BACKGROUND OF THE INVENTION

Embodiments of the invention relate to the management of cache memories, especially in the framework of dataflow processing in the form of networks of concurrent processes.

In a dataflow process, a series of data of the same nature, forming an incoming flow, is submitted to a succession of individual processes, for producing an outgoing dataflow. Exemplary processes that can be expressed as data flows are the filtering of an image, the compression/decompression of data (image, sound, a communication), the encryption/decryption of a communication, and the like.

FIG. 1 schematically shows a conventional processing system having a cache memory, which may serve, amongst others, for processing data flows. A processor (CPU) 10 communicates with a main memory 12 through an address bus A and a data bus D. The data and address buses are intercepted by a cache controller 14 configured, generally, to divert the memory accesses of the processor towards a cache memory 16.

Memory 12, usually external to the chip integrating the processor, is of slow access with respect to the possibilities of the processor. Cache memory 16 and its controller 14, being integrated on the same chip as the processor, are accessible at the maximum speed of the processor. It is thus desirable that the cache memory contain the most frequently used data by the processor.

The generic role of the controller 14 is the following. Each time the processor accesses data in main memory 12, controller 14 intercepts the access and diverts it towards cache memory 16. If the data happens to be in cache, the processor accesses it directly (cache hit). If the data is absent (cache miss), access is returned to main memory 12. While the processor accesses the missed data in main memory, the controller 14 writes the missed data in cache. In fact, the the controller writes in cache a whole line containing the missed data and the following consecutive data from the main memory, assuming that the data have spatial locality, i.e., the processor operates on consecutive data from the main memory.

The controller 14 is also responsible for flushing to the main memory 12 data that has been modified in cache. Such flushing generally takes place when the modified data in cache must be evicted, i.e., replaced by new data due to the unavailability of free locations in cache.

As shown in FIG. 1, the cache 16 includes a set of data lines 18, each of which is adapted to store a series of consecutive data, for example, eight 64-bit words. Each line 18 is associated with a tag field 20. A tag stored in a field 20 includes the most significant bits common to the addresses of the data stored in the associated line 18. The least significant bits not included in the tag are used to identify the position of the data in line 18.

A compare/select circuit 22 is configured to make accessible to the processor the data in lines 18 based on the addresses A provided by controller 14. Circuit 22 compares the most significant bits of the address A presented by controller 14 to the tags stored in the fields 20. In case of equality with one of the stored tags, the corresponding line 18 is selected, and the data of the line at the position identified by the least significant bits of the address A is made accessible to the processor via data bus D.

The operation that has just been described corresponds to a fully associative cache, which is disadvantageous in hardware cost and speed of access when the number of lines increases. Set associative caches are preferred. In this case, intermediate weight bits of addresses A are used to select one set of cache lines and corresponding tag fields among several sets.

A recurring problem in the management of cache memories is to ensure, with a relatively low available storage capacity, that they contain as often as possible the data requested by the processor. In other words, it is sought to increase the cache hit ratio when accessing the data. When the cache is full, a decision is to be taken to evict a line upon the next cache miss. A common cache management policy is to evict the least recently used line (LRU). However, regardless of the policy, it is uncertain to what extent the evicted line would actually be used less often than the newly written line.

To improve the situation, it has been considered to split the cache into several disjoint segments, and to dedicate each segment to data classified according to specific categories. The generic purpose of cache segmentation is that data of a first category do not evict data of a second category, which could be used as often as the data of the first category. There remains the problem of the definition of categories of data and the choice of segment sizes.

The article by M. Tomasko, S. Hadjiyiannis and W A Najjar, “Experimental Evaluation of Array Caches”, IEEE TCCA Newsletter, 1999, proposes to classify data as scalars (data corresponding to isolated values) and vectors (data in the form of arrays of values).

In the particular context of dataflow processing, the article by A. Naz, K M Kavi, P H Sweany and M. Rezaei, “A study of separate array and scalar caches”, Proceedings of the 18th International Symposium on High Performance Computing Systems and Applications, 157-164, 2004, and the article by K M Kavi, A R Hurson, P. Patadia, E. Abraham and P. Shanmugam, “Design of Cache memories for multi-threaded dataflow architecture”, ACM SIGARCH Computer Architecture News 23 (2), 1995, propose to classify data as scalar and indexed (tables and buffers associated with flows).

Also in the context of dataflow processing, U.S. Patent Application Publication No. 2007/0168615 proposes to dedicate a cache segment to each dataflow processed in parallel by a processor.

Among the solutions proposed for segmenting cache memory, none is really optimal, particularly in connection with the processing of data flows. There is therefore a need to provide a cache memory segmentation that is particularly well suited to processing data flows.

### BRIEF SUMMARY OF THE INVENTION

These and other needs can be addressed by embodiments of the present invention, which may include a cache memory associated with a main memory and a processor capable of executing a dataflow processing task. The cache memory includes a plurality of disjoint storage segments, each associated with a distinct data category. A first segment is dedicated to input data originating from a dataflow consumed by the processing task. A second segment is dedicated to output data originating from a dataflow produced by the processing task. A third segment is dedicated to global constants, corresponding to data available in a single memory location to multiple instances of the processing task.

According to an embodiment, the third segment includes a sub-segment containing exclusively global scalar constants, and a distinct sub-segment containing exclusively global vector constants.

According to an embodiment, the cache memory includes, in operation, a fourth segment containing exclusively local scalar variables, and a fifth segment containing exclusively local vector variables.

According to an embodiment, the cache memory includes, in operation, an additional segment containing exclusively input/output data originating from a same memory buffer where a processing task reads its input data, and writes its output data.

According to an embodiment, the cache memory is connected to the processor and to the main memory by an address bus and a data bus, the address bus having least significant bits defining the address space of the main memory and most significant bits capable of selecting individual segments from the cache.

According to an embodiment, the values of the most significant bits of the address bus are contained in an application program corresponding to the processing task.

A method is also provided for operating a cache memory of the above type, including the following steps carried out when the processor accesses the main memory: identifying input data as data originating from a dataflow consumed by the processing task, and storing them in a first segment of the cache memory; identifying output data as data originating from a dataflow produced by the processing task, and storing them in a second, distinct, segment of the cache memory; and identifying global constants corresponding to data available in a single memory location to multiple instances of the processing task, and storing them in a third, distinct, segment of the cache memory.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 previously described, schematically shows a processing system incorporating a cache memory;

FIG. 2 schematically shows a processing system incorporating a segmented cache memory;

FIG. 3 shows a succession of basic tasks in an exemplary dataflow process;

FIG. 4 is a graph comparing, for the execution of one of the tasks of FIG. 3, cache miss ratios for a non-segmented cache memory and an optimized segmented cache; and

FIG. 5 is a graph comparing the miss ratios when performing a complex task involving the use of many categories of data in a dataflow process.

### DETAILED DESCRIPTION OF THE INVENTION

Trials performed by the inventors on dataflow processes, using massively multicore computers, led the inventors to specific choices of cache segmentation.

“Cache segmentation” herein designates both the choice of assignment of each segment of the cache, and the hardware or software elements that control the storage of data in the segments that are assigned to them.

Segmentation has been studied here taking into account the fact that different categories of data involved in a dataflow process exhibit different types of locality.

We distinguish spatial locality, wherein data in adjacent memory locations are consumed sequentially by a task; temporal locality, where the same data are reused repeatedly in time; and spatiotemporal locality, where adjacent data in memory are, repeatedly in time, consumed successively by one or more tasks.

For example, in the case of a task having a consistent effect on its input and output channels, it is likely that the program implementing the task involves all the constants associated with the task. Scalar constants will tend to exhibit a temporal locality and vector constants (e.g., the coefficients of a convolution mask) will tend to exhibit a spatial locality. Similarly, the temporal locality of the constants is enhanced when the system executes the same task repeatedly on the same processor core, in which case a spatiotemporal locality of the vector constants may be expected in addition to a more pronounced temporal locality of the scalar constants. The above remarks apply analogously to data local to the task.

For reasons of detection and containment of errors, it is preferable to separate local variables and constants in different segments in order to benefit, using a memory protection function, of the read-only character of the local constants.

If it is difficult to predict the type of locality that the data stored in the stack may exhibit or not, the fact of providing the stack with its own segment may at least isolate the other data categories from side effects of a poorly controlled locality or an absence of locality of the stack data.

Finally, in the context of dataflow processes, it is very likely that the inputs and outputs of the task exhibit a pronounced spatial locality and no temporal locality (once consumed—respectively produced—the input data—respectively output data—are generally not used anymore).

It appears that such a segmentation mechanism significantly helps reduce performance variability due to the cache by discriminating between categories of data having different types of locality and by containing the categories of data exhibiting uncontrolled or low locality.

Based on these principles, a basic segmentation optimized for dataflow processes preferably comprises four segments respectively assigned to the following categories of data:
1. The input data consumed by the current processing task. These data are generally produced by a previous task in a processing chain, and stored in a buffer (FIFO) in main memory. The first task of the processing chain usually controls an interface with an input device (a camera, a network connection, a storage device, or the like).
2. The output data produced by the current processing task. These data are also stored in a buffer in main memory waiting to be consumed by the next task in the chain. The end task of the chain usually controls an interface with an output device (display device, a network connection, a storage device, or the like).
3. The global constants. These are constants defined specifically in the application program associated with the processing chain. By “global” it is understood that these constants are defined so that they are accessible to any instance of a subroutine corresponding to the current processing task. In other words, if multiple instances of the same task are running in parallel to process different sets of data, each of these instances can use the same global constants.
4. Data not falling into any of the above three categories, including the variables and the stack.

Note that the output data of a task are usually the input data of another task. These data output by the first task, and input to the second task, are assigned to two distinct cache segments (1 and 2), although they are stored in the same physical memory buffer. Thus, in theory, two cache segments may contain the same data, which could be a waste of resources. In practice, however, the lag between the time when a task produces data (written in segment 2), and the time when the same data is used (written in segment 1) by the next task is such that the data contained in the two segments are never duplicated.

The segments of the cache may be sized, for example, in the following way (for a 100-line cache—for other sizes, the lines may be distributed proportionally):

| | Segment | | | |
|---|---|---|---|---|
| | 1 | 2 | 3 | 4 |
| | (input data) | (output data) | (global constants) | (other) |
| Lines | 10 | 18 | 46 | 26 |

The gain obtained by this choice of segmentation will be seen below, using an example.

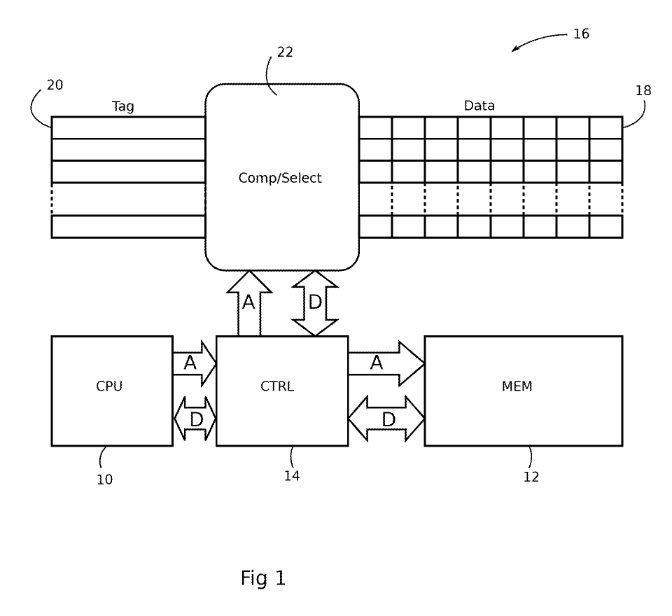

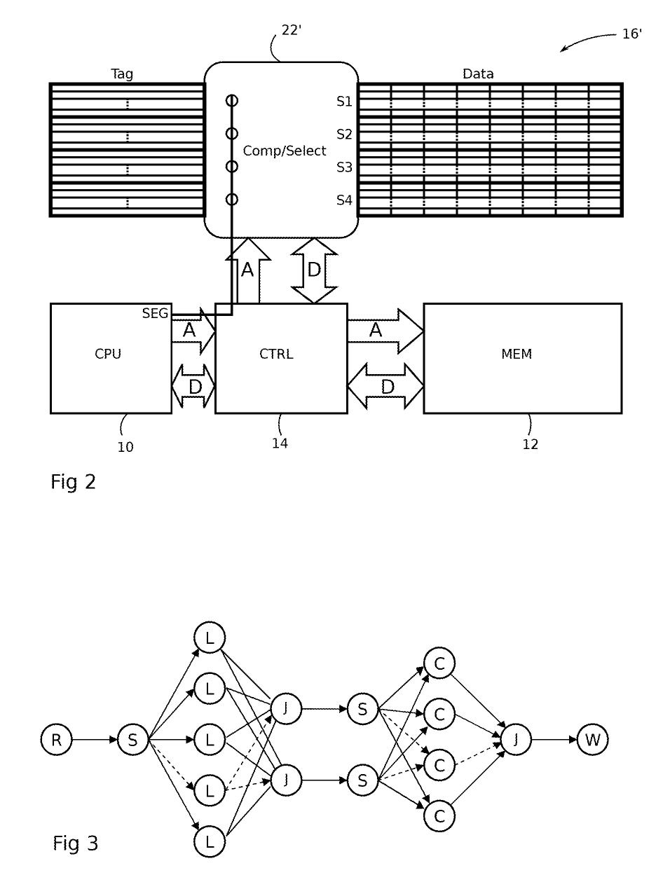

FIG. 2 schematically illustrates an embodiment of a processing system incorporating a four-segment cache, able to implement the above choice of segmentation. The same elements as in FIG. 1 are designated by the same references.

The cache and the compare/select circuit are here designated respectively by 16′ and 22′. These elements differ from their counterparts in FIG. 1 by the fact that they control cache lines divided into four disjoint segments S1 to S4.

In this embodiment, to select a cache segment to use, most significant bits SEG are provided that extend the addresses handled by processor 10, for example two bits to select one segment among four. Thus, whenever the processor 10 accesses a given address with the address bus A, it selects at the same time the associated cache segment with the extension bits SEG of the address bus.

This solution for assigning the segments also allows assigning a same memory space to several segments in the case where the data in this memory space, viewed by different tasks, belong to different categories. This is particularly the case for segments 1 and 2, as mentioned above, when the output data of one task are the input data of a next task.

Usually, the address bus A of the processor includes bits that are supernumerary for the memory space actually used. Thus, it is not necessary to enlarge the address bus of the processor—it suffices to take the SEG bits among the most significant supernumerary bits. The SEG bits have no effect on the behavior of the main memory 12 (or virtual memory, if any), which responds only to the least significant bits corresponding to the size of its address space.

The assignment of the SEG bits is preferably carried out at link time, after compiling the application program source code implementing the processing. The linker is responsible, amongst others, to define the address ranges of the data manipulated by the program. The linker, capable of identifying the different categories of data, may be designed to extend the allocated addresses with adequate selection bits SEG. These address ranges are then incorporated into the executable program. The processor running the program will use the address ranges to seamlessly select the segments.

FIG. 3 shows a series of basic tasks in an exemplary dataflow process. The example is the Deriche algorithm for detecting edges in an image. The process is divided into a series of basic tasks distributable on multiple cores of a multi-processor system, some of which may have multiple instances running in parallel.

From left to right, the process starts with a reading task R of the image data, for example from a storage device. A task S separates the lines of the image and feeds each line to a respective instance of a line-processing task L. Each task L produces two lines that have undergone different processing. The two lines produced by each task L feed respective instances of a task J for joining them to reconstitute an intermediate image. The intermediate images produced by tasks J are fed to respective instances of a task S that separate the columns of the images. Each pair of columns produced by the two tasks S is supplied to a respective instance of a column processing task C. The processed columns are joined by a task J to reconstruct the processed image, which is written to a storage device by a task W.

To evaluate the gain brought by the segmentation choice described above, the following task L is considered, which is the most complex among the above processes. This task is carried out by a subroutine of an application program that implements the entire process. In C language, this routine may be written:

1.void lineFilter (void)
2.{
3. static const int g1[11] = {−1, −6, −17, −17,
18, 46, 18, −17, −17, −6, −1},
g2[11] = {0, 1, 5, 17, 36, 46, 36, 17, 5, 1, 0}:
4. int i,j;
5. const int * const ptr_in1=getInputPtr(1);
6. int * const ptr_out1=getOutputPtr(1);
7. int * const ptr_out2=getOutputPtr(2);
8. for(i=0; i < width; i++)
9. {
10. ptr_out1[i]=0;
11. ptr_out2[i]=0;
12. if(i < width−11)
13. {
14. for(j=0; j < 11; j++)
15. {
16. _ptr_out[i]+=g1[j]*_ptr_in1[i+j];
17. _ptr_out2[i]+=g2[j]*_ptr_in1[i+j];
18. }
19. }
20. }
21. updateInputDesc(1);
22. updateOutputDesc(1);
23. updateOutputDesc(2);
24.}

Line 1 declares the subroutine as a function taking no parameters and returning no results.

Line 3 declares two arrays of constants, g1 and g2, each containing 11 convolution coefficients. Each of these arrays is subsequently used to calculate each of the two outgoing lines. In addition, these constants are specified as “static”, meaning that these constants are global in the sense that they are available in a single memory location for each instance of the function. Thus, these constants are related to segment 3 of the cache memory, as defined above.

Line 4 declares two loop indices i and j. These indices are assigned to segment 4 of the cache.

Line 5 declares a pointer to the buffer containing the input data, namely the pixels of the image line to be processed. Content identified by this pointer is assigned to segment 1 of the cache. In fact, pointers are retrieved by a call to an ad hoc application programming interface (API). The resulting pointer is called _ptr_in1 in the remainder of the function.

Lines 6 and 7 declare two pointers, called _ptr_out1 and _ptr_out2 in the function, to two buffers for respectively containing the two outgoing lines. The contents identified by these two pointers are thus allocated to segment 2 of the cache. These two pointers are also initialized by calls to an API.

It can be noted that the pointers declared in lines 5-7 point to an existing buffer (filled by a previous task) or to buffers that should be known to other tasks (for collecting their input data). These pointers could be defined as global variables in the “main” section of the source code of the program, whereby these pointers would be made available to all functions of the program, without the need to declare them within the functions. However, this is not so simple if multiple instances of the same function can be executed in parallel. Indeed, each instance working with different buffers. By using an API, the positioning of the pointers of each instance can be delegated to the linker, this positioning being parametric.

Lines 8 to 20 compute each pixel of the two outgoing lines as a linear combination of eleven successive pixels of the incoming line, the coefficients of the linear combination being contained in the arrays g1 (for the first outgoing line) and g2 (for the second outgoing line).

Lines 21 to 23 use an API to update the buffer descriptors, i.e., supporting data structures that allow, inter alia, determining the locations in the buffers to use for the data.

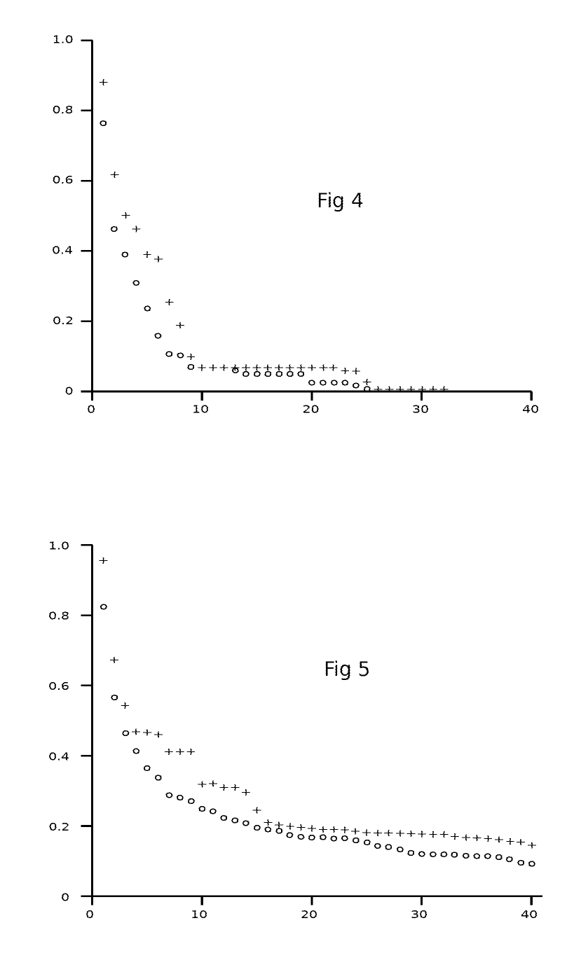

FIG. 4 is a graph illustrating, for multiple executions of the task L as defined above, the average gain obtained by a cache segmented according to the above choice. The graph represents the miss ratio as a function of the total number of rows in the cache. The miss ratio using a non-segmented cache is illustrated by “+”, while the miss ratio using a segmented cache is illustrated by “o”. The size used for a cache line is 8 words of 64 bits.

The task L being relatively simple, and the tests being performed without executing tasks in parallel, the miss ratio in both cases tends quickly to 0 after 26 lines. Note however that the miss ratio with the segmented cache is always lower than that obtained with a non-segmented cache. The best results are obtained between 20 and 24 lines, where the miss ratio with the segmented cache is 40% of the ratio obtained with a non-segmented cache. In the case of a very small cache, it is moreover possible to do better than an optimal offline policy (which would have knowledge of the future) to manage a non-segmented cache. This is not contradictory, but stems from the fact that, regardless of the effectiveness of the policy, it is sometimes beneficial to not cache some data at all.

Note that the graph starts at 1, 2 and 3 lines whereas segmentation into four segments is proposed. This means that the sizes of some segments are chosen zero in these cases. The results reflect the best allocation choice of segments of non-zero size. The results remain better with a segmented cache. This indicates that it is better to reserve the few available cache lines to data of a certain category and not cache data from other categories, rather than to cache all data.

FIG. 5 is a graph comparing miss ratios for the execution of a more complex task and probably more representative of a real environment dataflow process. The test was performed by introducing in the source code of function L so-called “substitution boxes” typically used in symmetric encryption algorithms. The resulting function does nothing useful, but its behavior is closer to a complex dataflow process. The source code of modified task L, in C language, is the following:

1.void lineFilter(void)
2.{
3. static const int g1[11] = {−1, −6, −17, −17, 18, 46, 18, −17,
−17, −6, −1}
g2[11] = {0, 1, 5, 17, 36, 46, 36, 17, 5, 1, 0};
4. static const int h1[11]={5,6,8,7,0,10,9,4,1,2,3};
5. static const int h2[11]={4,1,2,6,7,10,5,8,0,3,9};
6. static const int h3[11]={8,6,1,2,3,7,5,9,4,0,10};
7. const int h4[11]={2,7,4,9,5,8,1,10,3,6,0};
8. const int h5[11]={8,10,1,0,5,9,7,2,3,4,6};
9. int i,j;
10. const int * const ptr_in1=getInputPtr(1);
11. int * const ptr_out1=getOutputPtr(1);
12. int * const ptr_out1=getOutputPtr(2);
13. for(i=0; i < width; i++)
14. {
15. _ptr_out1[i]=0;
16. _ptr_out2[i]=0;
17. if(i < width-11)
18. {
19. for(j=0; j < 11; j++)
20. {
21. _ptr_out1[i+h4[j]]+=g1[h1[j]]* _ptr_in1[i+h2[j]];
22. _ptr_out2[i+h5[j]]+=g2[h1[j]]* _ptr_in1[i+h3[j]];
23. }
24. }
25. }
26. updateInputDesc(1);
27. updateOutputDesc(1);
28. updateOutputDesc(2);
29.}

Compared to the previous source code, three new arrays of global constants h1, h2 and h3 are introduced, as declared on lines 4 to 6. These arrays are assigned to segment 3 of the cache memory, like arrays g1 and g2. Two arrays of local constants h4 and h5 are also introduced, as declared in lines 7 and 8. These arrays are assigned to segment 4 of the cache memory, like the loop indices i and j. Arrays h4 and h5 could have been global constants like arrays h1 to h3, but they were voluntarily declared as local constants so that segment 4 is more used.

In the recursive calculations on the pixels performed between lines 13 and 25, the order of the input and output pixels and of the constants of arrays g1 and g2 is scrambled using arrays h1 to h5.

FIG. 5 shows a more regular evolution of the miss ratios as a function of the number of cache lines. These miss ratios, due to the fact that the task is more irregular, are higher than those of FIG. 4. However a marked systematic gain is observed when using a segmented cache according to the choices described above.

In a more sophisticated embodiment, offering additional optimization, eight cache segments may be provided, allocated to the following data categories:
1. Input/output data. In some cases, the data produced by a task may be written in the same buffer as the data consumed by the task. In other words, as the data are produced, they are written over the oldest consumed data, which are no longer used for the calculation of the produced data. Thus, a same buffer stores both the input data and output data.
2. Input data, in the case where the produced data is stored in a separate buffer than the input data.
3. Output data, in the case where they are stored in a separate buffer than the input data.
4. Global scalar constants. The constants containing individual values, for example the number Pi, Euler's constant, or any other constant involved punctually in calculations
5. Global vector constants. Arrays of values, for example matrix coefficients.
6. The stack. The stack is a temporary storage area used by the processor to store intermediate results, such as loop indices.
7. Local scalar variables. “Local” means that these variables are not accessible to other instances of the same task. For example, individual adaptive coefficients that are updated by iteration based on the particular data set processed by the task.
8. Local vector variables. For example, adaptive matrix coefficients.

The cache memory segments may be sized, for example, in the following manner:

| | | | | | | | | |
|---|---|---|---|---|---|---|---|---|
| Segment | 1 | 2 | 3 | 4 | 5 | 6 | 7 | 8 |
| Lines | 2 | 2 | 2 | 2 | 4 | 4 | 16 | 32 |

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A cache memory associated with a main memory and a processor capable of executing a dataflow processing task, the cache memory comprising a plurality of disjoint storage segments, each associated with a distinct data category, comprising, in operation:
a first segment containing exclusively input data originating from a dataflow consumed by the processing task;
a second segment containing exclusively output data originating from a dataflow produced by the processing task; and
a third segment containing exclusively global constants, corresponding to data available in a single memory location to multiple instances of the processing task.

2. The cache memory according to claim 1, wherein the third segment comprises:
a sub-segment containing exclusively global scalar constants, and
a distinct sub-segment containing exclusively global vector constants.

3. The cache memory according to claim 1, comprising, in operation:
a fourth segment containing exclusively local scalar variables, and
a fifth segment containing exclusively local vector variables.

4. The cache memory according to claim 1, comprising, in operation, an additional segment containing exclusively input/output data originating from a same memory buffer where a processing task reads its input data, and writes its output data.

5. The cache memory according to claim 1, connected to the processor and to the main memory by an address bus and a data bus, the address bus having least significant bits defining the address space of the main memory and most significant bits capable of selecting individual segments from the cache.

6. The cache memory according to claim 5, wherein the values of the most significant bits of the address bus are contained in an application program corresponding to the processing task.

7. A method for operating a cache memory associated with a main memory and a processor capable of executing a dataflow processing task, comprising a plurality of disjoint storage segments, each associated with a distinct data category, the method comprising, when the processor accesses the main memory:
identifying input data as data originating from a dataflow consumed by the processing task, and storing them in a first segment of the cache memory;
identifying output data as data originating from a dataflow produced by the processing task, and storing them in a second, distinct, segment of the cache memory; and
identifying global constants corresponding to data available in a single memory location to multiple instances of the processing task, and storing them in a third, distinct, segment of the cache memory.

8. The method according to claim 7, wherein the categories of data are identified by way of most significant bits of an address bus, these most significant bits being out of the address space of the main memory.

9. The method of claim 8 further comprising defining the most significant bits by a linking step performed after compiling the source code defining the processing task.
